(19) United States
(12) Patent Application Publication
(10) Pub. No.: US 2011/0281163 A1
(43) Pub. Date: Nov. 17, 2011

(54) NEGATIVE ELECTRODE FOR NON-AQUEOUS ELECTROLYTE SECONDARY BATTERY AND NON-AQUEOUS ELECTROLYTE SECONDARY BATTERY

(76) Inventors: Shinji Kasamatsu, Osaka (JP); Nobuhiro Hirano, Shiga (JP); Masaya Ugaji, Osaka (JP)

(21) Appl. No.: 13/147,139

(22) PCT Filed: Dec. 16, 2010
(86) PCT No.: PCT/JP2010/007298

§ 371 Date: Jul. 29, 2011

(30) Foreign Application Priority Data
Dec. 28, 2009 (JP) 2009-297714

(51) Int. Cl. H01M 4/133; B05D 3/00; H01M 4/04; H01M 10/05; H01M 4/62

(52) U.S. Cl. 429/213; 427/122

(57) ABSTRACT

A negative electrode for a non-aqueous electrolyte secondary battery includes a negative electrode core member and a negative electrode mixture layer adhering to the negative electrode core member. The negative electrode mixture layer includes graphite particles, a water-soluble polymer coating the surfaces of the graphite particles, and a binder bonding the graphite particles coated with the water-soluble polymer. The negative electrode mixture layer has a specific surface area of 2.2 to 3 m²/g, and the bonding strength between the graphite particles coated with the water-soluble polymer is 14 kgf/cm² or more. A non-aqueous electrolyte secondary battery including this electrode has good coulombic efficiency, since decomposition of the components of the non-aqueous electrolyte due to reaction between the graphite particles and the non-aqueous electrolyte is suppressed.

### TECHNICAL FIELD

This invention relates to a negative electrode for a non-aqueous electrolyte secondary battery including graphite particles as an active material, and more particularly, to an improvement in the negative electrode mixture layer.

### BACKGROUND ART

Various materials are used as active materials for the negative electrodes of non-aqueous electrolyte secondary batteries such as lithium ion secondary batteries. Among them, graphite materials capable of inserting and extracting lithium ions are mainly used, and such materials as natural graphites, artificial graphites, graphitized mesophase carbon particles, and graphitized mesophase carbon fibers are used.

For example, when graphite particles are used as a negative electrode active material, the graphite particles and a binder are mixed with a predetermined dispersion medium to form a negative electrode mixture slurry. The binder is usually polyvinylidene fluoride (PVDF), polytetrafluoroethylene (PTFE), styrene butadiene rubber (SBR), or the like. The negative electrode mixture slurry is applied onto a negative electrode core member comprising a copper foil or the like, and dried to form a negative electrode mixture layer. Thereafter, the negative electrode mixture layer is rolled with reduction rolls. The negative electrode mixture layer integrated with the negative electrode core member is cut to a predetermined shape, to obtain a negative electrode (see PTLs 1 and 2).

When a battery including such a negative electrode is repeatedly charged and discharged, the graphite particles expand and contract repeatedly due to insertion and extraction of lithium ions. Thus, the negative electrode mixture may separate from the negative electrode core member, thereby resulting in deterioration of cycle characteristics.

Therefore, in order to increase the bonding strength between the negative electrode mixture layer and the negative electrode core member to improve cycle characteristics, it has been proposed to set the average circularity of graphite particles serving as the negative electrode active material to 0.93 or more. This increases the bonding strength between the negative electrode mixture layer and the negative electrode core member determined by a cross-cut tape method to 8 or more (see PTL 3).

Non-aqueous electrolyte secondary batteries include a non-aqueous electrolyte comprising a non-aqueous solvent and a solute. The non-aqueous electrolyte is easily decomposed at the graphite particle surface during charging particularly in batteries which are in an initial stage of use, since the graphite particle surface is highly active with respect to decomposition reaction of non-aqueous electrolyte. If the non-aqueous electrolyte is decomposed, the coulombic efficiency of the battery lowers. As such, it has been proposed to coat the graphite particles with a water-soluble surfactant (see PTL 4).

### CITATION LIST

### Patent Literatures

PTL 1: Japanese Laid-Open Patent Publication No. 2008-277231
PTL 2: Japanese Laid-Open Patent Publication No. 2004-303572 (Patent No. 4151459)
PTL 3: Japanese Laid-Open Patent Publication No. 2002-216757
PTL 4: Japanese Laid-Open Patent Publication No. 2003-168432

### SUMMARY OF INVENTION

### Technical Problem

Merely improving the particle circularity of the graphite particles to increase the bonding strength between the negative electrode core member and the negative electrode mixture layer is not enough for improving cycle characteristics sufficiently. When the negative electrode mixture layer repeatedly expands and contracts due to charge/discharge cycles, the graphite particles may fall off the negative electrode mixture. It is believed that such fall-off of the graphite particles tends to occur when the bonding strength between the graphite particles is insufficient.

Also, according to conventional methods of negative electrode production, in the step of preparing a negative electrode mixture slurry and the step of rolling the negative electrode mixture layer (hereinafter may also be referred to as simply the production process of the negative electrode mixture layer), an excessive shearing force or stress is applied to part of the graphite particles. As a result, part of the particles become cracked, so that highly active sections are formed in the graphite particles. This facilitates the decomposition reaction of the non-aqueous electrolyte by the graphite particles.

Decreasing the specific surface area of the graphite particles can suppress the decomposition reaction of the non-aqueous electrolyte by the graphite particles, but this makes the rate characteristics of the battery insufficient. Also, graphite particles with a small specific surface area tend to become cracked in the production process of the negative electrode mixture layer.

### Solution to Problem

One aspect of the invention relates to a negative electrode for a non-aqueous electrolyte secondary battery, including a negative electrode core member and a negative electrode mixture layer adhering to the negative electrode core member. The negative electrode mixture layer includes graphite particles, a water-soluble polymer coating the surfaces of the graphite particles, and a binder bonding the graphite particles coated with the water-soluble polymer. The negative electrode mixture layer has a specific surface area of 2.2 to 3 m²/g, and the bonding strength between the graphite particles coated with the water-soluble polymer is 14 kgf/cm² or more.

Another aspect of the invention relates to a method for producing a negative electrode for a non-aqueous electrolyte secondary battery, including the steps of:

(i) mixing graphite particles with a specific surface area X of 4 to 6 m²/g, water, and a water-soluble polymer dissolved in the water, and drying the resulting mixture to obtain a dry mixture with a specific surface area Y of 2.9 to 4.3 m²/g where Y/X is from 0.6 to 0.8,

(ii) mixing the dry mixture, a binder, and a dispersion medium to form a negative electrode mixture slurry,

(iii) applying the negative electrode mixture slurry to a negative electrode core member and drying it to form a coating film, and

(iv) rolling the coating film at a line pressure of 40 to 60 kgf/cm to form a negative electrode mixture layer.

### Advantageous Effects of Invention

According to the invention, since the specific surface area of the negative electrode mixture layer is 2.2 to 3 m²/g, it is believed that the surfaces of the graphite particles are exposed to a suitable extent. Thus, sufficient rate characteristics are maintained and the decomposition reaction of the non-aqueous electrolyte is suppressed. Also, the bonding strength between the graphite particles coated with the water-soluble polymer is 14 kgf/cm² or more. Hence, even when the graphite particles expand and contract repeatedly, the expansion and contraction of the negative electrode mixture layer are suppressed. Therefore, the likelihood of new exposure of the graphite particle surface is reduced and the effect of suppressing the decomposition reaction of the non-aqueous electrolyte is further heightened.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is a schematic view of the state of graphite particles and a water-soluble polymer in a mixture of the graphite particles and the water-soluble polymer before drying;

FIG. 2 is a schematic view of the state of the graphite particles and the water-soluble polymer in the mixture of the graphite particles and the water-soluble polymer after drying; and

FIG. 3 is a schematic longitudinal sectional view of a prismatic lithium ion secondary battery according to one embodiment of the invention.

### DESCRIPTION OF EMBODIMENTS

The negative electrode according to the invention includes a negative electrode core member and a negative electrode mixture layer adhering to the negative electrode core member. The negative electrode mixture layer includes graphite particles, a water-soluble polymer coating the surfaces of the graphite particles, and a binder bonding the graphite particles coated with the water-soluble polymer. By coating the graphite particle surface with the water-soluble polymer, the degree of exposure of the graphite particle surface can be controlled suitably, and the bonding strength between the graphite particles is significantly increased.

The specific surface area of the negative electrode mixture layer is controlled at 2.2 to 3 m²/g, preferably 2.6 to 3 m²/g, more preferably 2.6 to 2.8 m²/g, and even more preferably 2.65 to 2.8 m²/g. If the specific surface area of the negative electrode mixture layer is smaller than 2.2 m²/g, sufficient rate characteristics cannot be obtained. If the specific surface area exceeds 3 m²/g, the graphite particle surface is not sufficiently coated with the water-soluble polymer, so that the degree of exposure of the graphite particle surface increases. This facilitates the decomposition of the non-aqueous electrolyte, thereby lowering coulombic efficiency.

Even when graphite particles with a small specific surface area are used, the specific surface area of the resulting negative electrode mixture layer is approximately 3.3 m²/g in many cases. However, by coating the graphite particle surface with a water-soluble polymer, the specific surface area of the negative electrode mixture layer can be controlled at 3 m²/g or less, and sufficient rate characteristics can be maintained. In this case, in the production process of the negative electrode mixture layer, application of an excessive shearing force or stress to part of the graphite particles can be suppressed. As a result, the occurrence of cracking in the graphite particles is reduced, and highly active sections are unlikely to be formed in the graphite particles.

The bonding strength between the graphite particles coated with the water-soluble polymer is controlled at 14 kgf/cm² or more, preferably 17 kgf/cm² or more, and more preferably 20 kgf/cm² or more. It should be noted that the upper limit of the bonding strength between the graphite particles is approximately 30 kgf/cm², and that making it higher than this is unrealistic. By this, even when the negative electrode mixture layer expands and contracts repeatedly due to charge/discharge cycles, the graphite particles are unlikely to fall off. Also, since the distance between the graphite particles is unlikely to increase, swelling of the battery due to increased negative electrode thickness can be reduced. Therefore, the likelihood of new exposure of the graphite particle surface is reduced and the effect of suppressing the decomposition reaction of the non-aqueous electrolyte is further heightened.

The specific surface area of the negative electrode mixture layer and the bonding strength between the graphite particles are affected by the specific surface area of the raw material graphite particles, the degree of coating of the graphite particles with the water-soluble polymer, the conditions for preparing the negative electrode mixture slurry, the conditions for rolling the negative electrode mixture layer, etc. It is thus necessary to control these conditions appropriately. For example, it is preferable to produce the negative electrode by the production methods described below. Herein, Method A and Method B are described as examples.

First, Method A is described.

Method A includes the step (step (i)) of mixing graphite particles, water, and a water-soluble polymer dissolved in the water and drying the resulting mixture to obtain a dry mixture with a specific surface area of 2.9 to 4.3 m²/g. For example, a water-soluble polymer is dissolved in water to form a water-soluble polymer aqueous solution. The water-soluble polymer aqueous solution is mixed with graphite particles (raw material graphite particles), and then the water content is removed to dry the mixture. In this manner, by drying the mixture, the water-soluble polymer efficiently adheres to the graphite particle surface, so that the coating rate of the graphite particle surface with the water-soluble polymer is heightened.

The specific surface area of the raw material graphite particles is preferably 4 to 6 m²/g, and more preferably 4.5 to 5.5 m²/g. In this case, it becomes easy to control the specific surface area of the negative electrode mixture layer in the predetermined range. Also, the sliding properties of the graphite particles in the negative electrode mixture layer are improved, which is advantageous to increasing the bonding strength between the graphite particles.

The graphite particles used as the negative electrode active material generically refer to particles including a region of graphite structure. Therefore, the graphite particles include such materials as natural graphites, artificial graphites, and graphitized mesophase carbon particles. These graphite particles can be used singly or in combination.

The diffraction pattern of graphite particles measured by a wide-angle X-ray diffraction analysis has a peak attributed to the (110) face and a peak attributed to the (004) face. With respect to the ratio of the intensity I(110) of the peak attributed to the (110) face to the intensity I(004) of the peak attributed to the (004) face, preferably 0.01<I(110)/I(004)<0.25, and more preferably 0.08<I(110)/I(004)<0.2. The intensity of the peak as used herein refers to the height of the peak.

The mean particle size (median diameter) of the graphite particles is preferably 14 to 22 μm, and more preferably 16 to 20 μm. When the mean particle size is in the above-mentioned range, the sliding properties of the graphite particles in the negative electrode mixture layer are improved, and the state of the packed graphite particles is good, which is advantageous to increasing the bonding strength between the graphite particles. As used herein, the mean particle size refers to the particle size (D50) in the particle size distribution of graphite particles at which the cumulative volume is 50%. The volume basis particle size distribution of graphite particles can be determined with a commercially available laser diffraction particle size distribution analyzer (e.g., Microtrac available from Nikkiso Co., Ltd.).

The average circularity of the graphite particles is preferably 0.9 to 0.95, and more preferably 0.91 to 0.94. When the average circularity is included in the above-mentioned range, the sliding properties of the graphite particles in the negative electrode mixture layer are improved, which is advantageous to improving the packing properties of the graphite particles and increasing the bonding strength between the graphite particles. The average circularity is expressed as 4 πS/L² (S represents the area of the orthogonally projected image of each graphite particle and L represents the length of the circumference of the orthogonally projected image). For example, the average value of the circularities of given 100 graphite particles is preferably in the above-mentioned range.

The specific surface area of the dry mixture is preferably 2.9 to 4.3 m²/g, and more preferably 2.9 to 4 m²/g. In this case, the degree of coating of the graphite particles with the water-soluble polymer becomes good, and the water-soluble polymer effectively functions as a lubricant for increasing the flowability of the graphite particles. Thus, in the production process of the negative electrode mixture layer, an excessive shearing force or stress is unlikely to be applied to the graphite particles. When the specific surface area of the raw material graphite particles is represented by X and the specific surface area of the dry mixture is represented by Y, the graphite particle surface is coated with the water-soluble polymer so that the Y/X ratio is from 0.6 to 0.8.

The viscosity of the water-soluble polymer aqueous solution is preferably controlled at 1000 to 10000 cP (i.e., 1 to 10 Pa·s) at 25° C. The viscosity is measured by using a B-type viscometer and a 5-mm φ spindle at a circumferential velocity of 20 mm/s. Also, the amount of graphite particles to be mixed with 100 parts by weight of the water-soluble polymer aqueous solution is preferably 50 to 150 parts by weight.

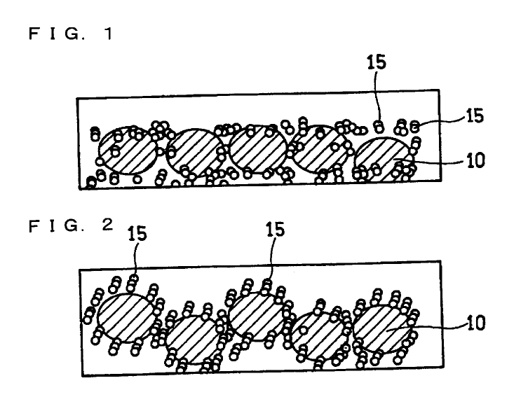

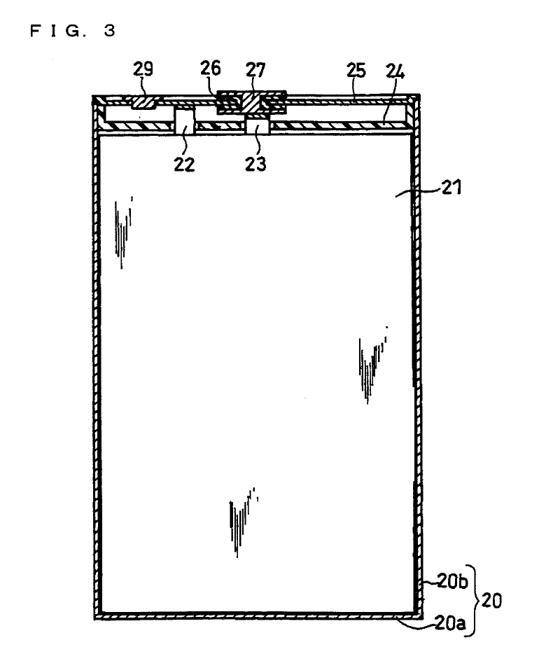

The drying temperature of the mixture is preferably 80 to 150° C., and the drying time is preferably 1 to 8 hours. FIG. 1 and FIG. 2 schematically illustrate the state of the graphite particles and the water-soluble polymer in the mixture before and after drying, respectively. In FIG. 1 illustrating the state before drying, the ratio of a water-soluble polymer 15 in contact with the surfaces of graphite particles 10 is relatively small. In FIG. 2 illustrating the state after drying, the ratio of the water-soluble polymer 15 in contact with the surfaces of the graphite particles 10 has increased.

Next, the dry mixture thus obtained is mixed with a binder and a dispersion medium to form a negative electrode mixture slurry (step (ii)). At this time, it is also possible to further add the water-soluble polymer. In this step, the binder adheres to the graphite particle surface coated with the water-soluble polymer. Since the graphite particles have good sliding properties, the binder adhering to the graphite particle surface is subjected to a sufficient shearing force and acts on the graphite particle surface effectively.

Thereafter, the negative electrode mixture slurry is applied onto a negative electrode core member and dried to form a negative electrode mixture layer, to obtain a negative electrode (step (iii)). The method for applying the negative electrode mixture slurry to the negative electrode core member is not particularly limited. For example, using a die coater, the negative electrode mixture slurry is applied onto a roll of a negative electrode core member in a predetermined pattern. The drying temperature of the coating film is not particularly limited either. The dried coating film is rolled with reduction rolls and controlled at a predetermined thickness. The rolling step increases the bonding strength between the negative electrode mixture layer and the negative electrode core member and the bonding strength between the graphite particles coated with the water-soluble polymer. The rolling is performed preferably at a line pressure of 40 to 60 kgf/cm, and more preferably at a line pressure of 40 to 55 kgf/cm. In this case, cracking of the graphite particles is suppressed, and the degree of exposure of highly active section can be reduced. The negative electrode mixture layer prepared in this manner is cut to a predetermined shape together with the negative electrode core member, to complete the negative electrode.

Next, Method B will be described.

Method B includes the step (step (i)) of mixing graphite particles, a binder, water, and a water-soluble polymer dissolved in the water and drying the resulting mixture to obtain a dry mixture. For example, a water-soluble polymer is dissolved in water to prepare a water-soluble polymer aqueous solution. The viscosity of the water-soluble polymer aqueous solution can be the same as that in Method A. Subsequently, the water-soluble polymer aqueous solution thus obtained is mixed with a binder and graphite particles, and then the water content is removed to dry the mixture. In this manner, by drying the mixture, the water-soluble polymer and the binder efficiently adhere to the graphite particle surface. Therefore, the coating rate of the graphite particle surface with the water-soluble polymer is heightened, and the binder adheres to the graphite particle surface in a good state. In terms of heightening the dispersibility of the binder in the water-soluble polymer aqueous solution, it is preferable to mix an aqueous dispersion of the binder, which uses water as the dispersion medium, with the water-soluble polymer aqueous solution. The specific surface area X of the raw material graphite particles, the specific surface area Y of the dry mixture, and the Y/X ratio can be the same as those in Method A.

Subsequently, the dry mixture thus obtained is mixed with a dispersion medium to prepare a negative electrode mixture slurry (step (ii)). At this time, the water-soluble polymer and/or binder may be further added. In this step, the graphite particles coated with the water-soluble polymer and the binder swell with the dispersion medium to some extent, so that the sliding properties of the graphite particles become good.

In both Method A and Method B, in the step (ii), it is preferable to mix the dry mixture, the binder, and the dispersion medium with a load smaller than the largest load of the load usually applied. In this case, in the preparation of the negative electrode mixture slurry, the graphite particles are unlikely to crack, and exposure of highly active section can be further suppressed.

Thereafter, the negative electrode mixture slurry thus obtained is applied onto a negative electrode core member in the same manner as in Method A, dried, and rolled to form a negative electrode mixture layer, to obtain a negative electrode (step (iii)).

It should be noted that there is also another production method in which graphite particles, a water-soluble polymer, and a binder are mixed to form a negative electrode mixture slurry, and without a drying step, the negative electrode mixture slurry is applied onto a negative electrode core member, dried, and rolled to form a negative electrode mixture layer. However, when such a method is used to produce a negative electrode, the graphite particle surface is not sufficiently coated with the water-soluble polymer. It is thus difficult to make the specific surface area of the negative electrode mixture layer 2.2 to 3 m²/g, and it is also difficult to make the bonding strength between the graphite particles coated with the water-soluble polymer 14 kgf/cm² or more.

In Method A and Method B, the dispersion medium used to prepare the negative electrode mixture slurry is not particularly limited. It is preferably water or an aqueous alcohol solution, and most preferably water. A non-aqueous solvent such as N-methyl-2-pyrrolidone (hereinafter NMP) may also be used.

The kind of the water-soluble polymer is not particularly limited, and examples include: cellulose derivatives; and polyvinyl alcohol, polyvinyl pyrrolidone, and derivatives thereof. Among them, cellulose derivatives are particularly preferable. Preferable cellulose derivatives include methyl cellulose, carboxymethyl cellulose, and Na salts of carboxymethyl cellulose. The molecular weight of the cellulose derivative is preferably 10,000 to 1,000,000, and more preferably 50,000 to 500,000. Also, the degree of etherification of the cellulose derivative is preferably 0.6 to 1. These water-soluble polymers can be used singly or in combination.

The amount of the water-soluble polymer contained in the negative electrode mixture layer is preferably 0.5 to 2.5 parts by weight per 100 parts by weight of the graphite particles, and more preferably 0.7 to 1 part by weight. When the amount of the water-soluble polymer is within the above range, the water-soluble polymer can easily coat the graphite particle surface at a high coating rate. Thus, the decomposition of the electrolyte components by the reaction between the graphite particles and the non-aqueous electrolyte can be suppressed effectively. It is thus possible to improve the coulombic efficiency of the non-aqueous electrolyte secondary battery. Also, the graphite particle surface is not excessively coated with the water-soluble polymer, and the internal resistance of the negative electrode can be further decreased.

The binder to be contained in the negative electrode mixture layer is preferably in the form of particles and has rubber elasticity.

Also, the binder particles preferably have a mean particle size of 0.1 to 0.3 μm, and more preferably satisfy the following conditions:

(a) In the particle size distribution of the binder, the particle size (D50) at which the cumulative volume is 50% is 0.1 μm to 0.15 μm; and

(b) In the particle size distribution of the binder, the particle size (D90) at which the cumulative volume is 90% is 0.18 μm or less.

The volume basis particle size distribution of the binder can be determined by using, for example, Microtrac of Nikkiso Co., Ltd.

Such a binder has a good affinity with the graphite particle surface coated with the water-soluble polymer, and can be easily and evenly attached to the graphite particles. Thus, the bonding points between the graphite particles increase, and the distribution of the bonding points becomes more even. Also, a binder with rubber elasticity has the function of reducing the internal stress of the negative electrode mixture layer. Hence, mutual adhesion is heightened, and the bonding strength between the graphite particles is further increased.

When the particle size (D50) at which the cumulative volume is 50% is 0.1 μm to 0.15 μm, i.e., when the mean particle size of the binder is relatively smaller than conventional one, the bonding points between the graphite particles increase and the distribution of the bonding points becomes more even. Also, a binder with such a particle size does not impair the contact between the graphite particles even when it is present between the graphite particles.

Further, when the particle size (D90) at which the cumulative volume is 90%, which is relatively large, is 0.18 μm or less, the distribution of the bonding points becomes more even. Also, the adhesion of the graphite particles becomes highly even, and the bonding strength between the graphite particles increases significantly. Thus, the bonding strength between the graphite particles coated with the water-soluble polymer becomes very high.

The binder in the form of particles having rubber elasticity and a sufficiently small mean particle size is preferably a polymer including a styrene unit and a butadiene unit. Such a polymer has good elasticity and is stable at the potential of the negative electrode. The amount of the butadiene unit is preferably 30 to 70 mol % of the total of the styrene unit and the butadiene unit included in the polymer serving as the binder. The amount of the other monomer units than the styrene unit and the butadiene unit is preferably equal to or less than 40 mol % of all the monomer units.

The amount of the binder contained in the negative electrode mixture layer is preferably 0.4 to 1.5 parts by weight per 100 parts by weight of the graphite particles, and more preferably 0.6 to 1.2 parts by weight. When the water-soluble polymer coats the graphite particle surface, the sliding properties of the graphite particles are good. Thus, the binder adhering to the graphite particle surface is subjected to a sufficient shearing force and acts on the graphite particle surface effectively. Therefore, even when the amount of the binder is small, sufficient adhesion is exhibited, and both bonding property and high battery capacity can be easily obtained.

It is particularly preferable that the water-soluble polymer include a cellulose derivative and that the binder be in the form of particles and have rubber elasticity and a mean particle size of 0.1 to 0.3 μm. In this case, the specific surface area of the negative electrode mixture layer can be controlled favorably, and the decomposition of the electrolyte components can be suppressed effectively. Therefore, the coulombic efficiency of the non-aqueous electrolyte secondary battery is further improved.

The non-aqueous electrolyte secondary battery of the invention includes the above-described negative electrode, a positive electrode capable of electrochemically absorbing and desorbing Li, a separator interposed between the negative electrode and the positive electrode, and a non-aqueous electrolyte. The invention is applicable to non-aqueous electrolyte secondary batteries of various shapes, such as cylindrical, flat, coin, and prismatic shapes, and the battery shape is not particularly limited.

The positive electrode is not particularly limited if it can be used as the positive electrode for non-aqueous electrolyte secondary batteries. The positive electrode can be produced by, for example, applying a positive electrode mixture slurry including a positive electrode active material, a conductive agent such as carbon black, and a binder such as polyvinylidene fluoride onto a positive electrode core member such as an aluminum foil, drying it, and rolling it.

The positive electrode active material is preferably a lithium-containing transition metal oxide. Representative examples of lithium-containing transition metal oxides include LiCoO₂, LiNiO₂, LiMn₂O₄, LiMnO₂, LiNi_{1-y}CO_{y}O₂ where 0<y<1, and LiNi_{1-y-z}Co_{y}Mn_{z}O₂ where 0<y+z<1. These positive electrode active materials can be used singly or in combination.

The non-aqueous electrolyte is preferably a liquid electrolyte comprising a non-aqueous solvent and a lithium salt dissolved therein. The non-aqueous solvent is usually a solvent mixture comprising a cyclic carbonate such as ethylene carbonate or propylene carbonate and a chain carbonate such as dimethyl carbonate, diethyl carbonate, or ethyl methyl carbonate. Additionally, γ-butyrolactone or dimethoxyethane may also be used. These non-aqueous solvents can be used singly or in combination. Examples of lithium salts include inorganic lithium fluorides and lithium imide compounds. Examples of inorganic lithium fluorides include LiPF₆ and LiBF₄, and examples of lithium imide compounds include LiN(CF₃SO₂)₂. These lithium salts can be used singly or in combination.

The separator is commonly a microporous film made of polyethylene or polypropylene. The thickness of the separator is, for example, 10 to 30 μm.

The invention is hereinafter described by way of Examples and Comparative Examples. However, the invention is not to be construed as being limited to the following Examples.

### EXAMPLES

### Example 1

### (a) Preparation of Negative Electrode

### Step (i)

First, carboxymethyl cellulose (hereinafter CMC; molecular weight 200,000 and degree of etherification 0.7) serving as a water-soluble polymer was dissolved in water to obtain an aqueous solution with a CMC concentration of 0.7% by weight. The viscosity of the 0.7 wt % CMC aqueous solution was measured with a B-type viscometer, and was found to be 1.5 Pa·s. 100 parts by weight of natural graphite particles (mean particle size 18 μm, average circularity 0.92, and specific surface area 4.8 m²/g) and 100 parts by weight of the CMC aqueous solution were mixed, and the mixture was stirred while the temperature of the mixture was controlled at 25° C. Thereafter, the mixture was dried at 80° C. for 5 hours to obtain a dry mixture. The amount of CMC in the dry mixture per 100 parts by weight of the graphite particles was 0.7 part by weight.

The specific surface areas of the natural graphite particles and the dry mixture were measured with macsorb HM model-1201 of Mountech Co., Ltd. according to a nitrogen adsorption method using nitrogen (N₂) as the adsorption gas.

The amount of the sample for the measurement of specific surface area was set to 2 g. Nitrogen was introduced into the analyzer to measure the specific surface area of the natural graphite particles.

The dry mixture was passed through a sieve with an opening of 75 μm to prepare a sample for the measurement of specific surface area. Using 2 g of this sample, the specific surface area of the dry mixture was measured in the same manner as that of the natural graphite particles, and was found to be 3.4 m²/g.

### Step (ii)

A negative electrode mixture slurry was prepared by mixing 100.7 parts by weight of the dry mixture (i.e., 100 parts by weight of graphite+0.7 part by weight of CMC), an aqueous dispersion containing 0.6 part by weight of a particulate binder including a styrene unit and a butadiene unit and having rubber elasticity (hereinafter “SBR”), and 100 parts by weight of water. It should be noted that the SBR was in the form of an aqueous dispersion using water as the dispersion medium (available from JSR Corporation, SBR content of 48% by weight) when mixed with the other components (the amount of the aqueous dispersion used was 1.25 parts by weight).

The particle size (D50) at which the cumulative volume of SBR was 50% was 0.12 μm, and the particle size (D90) at which the cumulative volume was 90% was 0.15 μm.

Step (iii)

The negative electrode mixture slurry was applied onto both faces of an electrolytic copper foil (thickness 10 μm) serving as a negative electrode core member by using a die coater, and the coating films were dried at 110° C. The dried coating films were then rolled at a line pressure of 50 kgf/cm with reduction rollers to form negative electrode mixture layers with a thickness of 145 μm and a graphite density of 1.6 g/cm³. The negative electrode mixture layers and the negative electrode core member were cut to a predetermined shape to obtain a negative electrode.

### (b) Preparation of Positive Electrode

A positive electrode mixture slurry was prepared by adding 4 parts by weight of polyvinylidene fluoride (PVDF) serving as a binder to 100 parts by weight of LiCoO₂ serving as a positive electrode active material and mixing them with a suitable amount of NMP. The positive electrode mixture slurry was applied onto both faces of a 15-μm thick aluminum foil serving as a positive electrode core member by using a die coater, and the coating films were dried and rolled to form positive electrode mixture layers. The positive electrode mixture layers and the positive electrode core member were cut to a predetermined shape to obtain a positive electrode.

### (c) Preparation of Non-Aqueous Electrolyte

A non-aqueous electrolyte was prepared by dissolving LiPF₆ at a concentration of 1 mol/liter in a solvent mixture of ethylene carbonate (EC), dimethyl carbonate (DMC), and ethyl methyl carbonate (EMC) in a volume ratio of 1:1:1. The non-aqueous electrolyte was mixed with 3% by weight of vinylene carbonate.

### (d) Fabrication of Battery

A prismatic lithium ion secondary battery as illustrated in FIG. 3 was produced.

The negative electrode and the positive electrode were wound with a separator comprising a 20-μm thick polyethylene microporous film (A089 (trade name) available from Celgard K. K.) interposed therebetween, to form an electrode assembly 21 with a substantially oval section. The electrode assembly 21 was placed in an aluminum prismatic battery can 20. The battery can 20 has a bottom 20a, a side wall 20b, and an open top. The main flat portion of the side wall 20b has a rectangular shape and a thickness of 80 μm. Thereafter, an insulator 24 for preventing a short circuit between the battery can 20 and a positive electrode lead 22 or a negative electrode lead 23 was mounted on top of the electrode assembly 21. Subsequently, a rectangular seal plate 25 having, at the center, a negative electrode terminal 27 surrounded by an insulating gasket 26 was fitted to the opening of the battery can 20. The negative electrode lead 23 was connected to the negative electrode terminal 27. The positive electrode lead 22 was connected to the lower face of the seal plate 25. The edge of the opening and the seal plate 25 were welded with a laser to seal the opening of the battery can 20. Thereafter, 2.5 g of the non-aqueous electrolyte was injected into the battery can 20 from the injection hole of the seal plate 25. Lastly, the injection hole was closed with a seal stopper 29 by welding, to complete a prismatic lithium ion secondary battery with a height of 50 mm, a width of 34 mm, an inner space thickness of approximately 5.2 mm, and a design capacity of 850 mAh.

### [Measurement of Specific Surface Area of Roll-Pressed Negative Electrode Mixture Layer]

The specific surface area of the roll-pressed negative electrode mixture layer was measured by the following method using a BET specific surface area analyzer in the same manner as the measurements of the specific surface areas of the natural graphite particles and the dry mixture.

The battery was disassembled, and the negative electrode was taken out and dried. The negative electrode mixture was peeled from the negative electrode core member. The peeled negative electrode mixture was crushed and passed through a sieve with an opening of 75 μm to prepare a sample for the measurement of specific surface area. The amount of the sample was made 2 g. Using 2 g of the sample, the specific surface area of the roll-pressed negative electrode mixture layer was measured in the same manner as the natural graphite particles and the dry mixture. Table 1 shows the results.

### [Evaluation of Negative Electrode]

The bonding strength between the graphite particles coated with the water-soluble polymer in the negative electrode mixture layer was measured by the following method.

A tack tester (TAC-II available from RHESCA Corporation Limited) was used. First, the negative electrode to be evaluated was cut to a shape of 2 cm×3 cm to prepare an electrode sample. A double-faced tape (No. 515 available from Nitto Denko Corporation) was affixed to a glass plate. The negative electrode mixture layer was peeled from one face of the electrode sample, and the other face (the negative electrode mixture layer side) was affixed to the double-faced tape of the glass substrate. Thereafter, the negative electrode core member was peeled from the negative electrode mixture layer adhering to the double-faced tape to expose the negative electrode mixture layer, to prepare an evaluation sample.

A double-faced tape, which was the same as the one used above, was attached to the tip of the probe of the tack tester (tip diameter 0.2 cm), and a peel test was performed under the following conditions.

### <Tack Test Condition>

Pushing speed: 30 mm/min

Pushing time: 10 seconds

Pushing load: 0.4 kgf

Pull-up speed: 600 mm/min

The probe was pushed in and the largest load required for pulling up the probe was measured. The value obtained by dividing the largest load by the cross sectional area (0.031 cm²) of the probe was obtained as bonding strength (kgf/cm²). After the completion of the measurement, the peeled surface of the evaluation sample on the probe side was observed, and it was confirmed that separation occurred between the graphite particles.

### [Evaluation of Prismatic Battery]

In an environment of 20° C., 100 charge/discharge cycles were performed under the following conditions. The percentage of the discharge capacity at the 100^{th} cycle relative to the discharge capacity at the 1^{st} cycle (capacity retention rate) was obtained.

### <Cycle Test Condition>

Constant current charge: Charge current value 850 mA/End-of-charge voltage 4.2 V

Constant voltage charge: Charge voltage value 4.2 V/End of charge current 100 mA

Constant current discharge: Discharge current value 1700 mA/End-of-discharge voltage 3 V

### [Evaluation of Rate of Increase in Thickness]

Also, using the negative electrode, a coin battery for evaluating the rate of increase in thickness was produced. Specifically, the negative electrode was punched into a diameter of 12.5 mm φ, and was mounted on a shallow case having a bottom with a spacer therebetween. A separator (thickness 16 μm, ND416 available from Asahi Kasei Corporation) was disposed on the negative electrode, and the non-aqueous electrolyte was injected therein. Subsequently, a lithium foil punched into a diameter of 18 mm φ, serving as a counter electrode, was affixed to the inner face of a seal plate, and the counter electrode was disposed so as to face the negative electrode with the separator therebetween. The opening of the case with the bottom was sealed with the seal plate.

The coin battery thus produced was charged and discharged three times under the following conditions. Lastly, it was polarized until lithium was inserted in the negative electrode. The coin battery was disassembled, the negative electrode was collected, and its thickness was measured. The rate of increase (%) was determined from the negative electrode thickness after the 3.5 charge/discharge cycles relative to the negative electrode thickness immediately before the fabrication of the coin battery. The result is shown in Table 1.

### <Charge/Discharge Test Condition>

Constant current charge: Charge current value 0.15 mA/cm², End-of-charge voltage 0.01 V

Constant current discharge: Discharge current value 0.15 mA/cm², End-of-discharge voltage 1.5 V

### Comparative Example 1

Using the same method and materials as those of Example 1, a CMC aqueous solution was prepared, and 100 parts by weight of natural graphite particles and 100 parts by weight of the CMC aqueous solution were mixed. The resulting mixture was mixed with 1.25 parts by weight of the same SBR aqueous dispersion (SBR content 48% by weight) as that used in Example 1 and a suitable amount of water, and they were sufficiently mixed to prepare a negative electrode mixture slurry. Using the negative electrode mixture slurry, a negative electrode was produced in the same manner as in Example 1. Using the negative electrode, a lithium ion secondary battery was produced in the same manner as in Example 1. The negative electrode and the battery were evaluated in the same manner as in Example 1.

### Example 2

A negative electrode was produced in the same manner as in Example 1, except that in the step (iii), the dried coating films were rolled with reduction rollers at a line pressure of 40 kgf/cm. Using this negative electrode, a lithium ion secondary battery was produced in the same manner as in Example 1. The negative electrode and the battery were evaluated in the same manner as in Example 1.

### Comparative Example 2

A negative electrode was produced in the same manner as in Comparative Example 1, except that the dried coating films were rolled under the same conditions as those of Example 2. Using this negative electrode, a lithium ion secondary battery was produced in the same manner as in Example 1. The negative electrode and the battery were evaluated in the same manner as in Example 1.

### Example 3

A negative electrode was produced in the same manner as in Example 1, except that in the step (iii), the dried coating films were rolled with reduction rollers at a line pressure of 60 kgf/cm. Using this negative electrode, a lithium ion secondary battery was produced in the same manner as in Example 1. The negative electrode and the battery were evaluated in the same manner as in Example 1.

### Comparative Example 3

A negative electrode was produced in the same manner as in Comparative Example 1, except that the dried coating films were rolled under the same conditions as those of Example 3. Using this negative electrode, a lithium ion secondary battery was produced in the same manner as in Example 1. The negative electrode and the battery were evaluated in the same manner as in Example 1.

The results of Examples 1 to 3 and Comparative Examples 1 to 3 are shown in Table 1.

TABLE 1

| | | Specific | | | Rate of |
|---|---|---|---|---|---|
| | Specific | surface area | | | increase in |
| | surface area | of negative | | | thickness |
| | of dry | electrode | | | of coin |
| | mixture | mixture | Tack test | Cycle | battery |
| | (m²/g) | layer (m²/g) | (kgf/cm²) | test (%) | (%) |
| Example 1 | 3.4 | 2.7 | 15.2 | 93 | 12 |
| Comparative | — | 3.5 | 11.2 | 90 | 19 |
| Example 1 | | | | | |
| Example 2 | 3.4 | 2.6 | 16.2 | 94 | 13 |
| Comparative | — | 3.4 | 12.3 | 90 | 20 |
| Example 2 | | | | | |
| Example 3 | 3.4 | 2.8 | 14.5 | 92 | 11 |
| Comparative | — | 3.6 | 10.2 | 89 | 19 |
| Example 3 | | | | | |

As shown in Table 1, when Examples 1 to 3 were compared with Comparative Examples 1 to 3, the batteries of Examples 1 to 3 exhibited good cycle characteristics and small rates of increase in thickness. From this, it can be understood that as in Method A, the use of a dry mixture of graphite particles and a water-soluble polymer to form a negative electrode mixture layer is important. Of Examples 1 to 3, Example 2 in which the rolling was performed at a line pressure of 40 kgf/cm exhibited a particularly good cycle characteristic.

### Example 4

Negative electrodes were produced in the same manner as in Example 1, except that in the step (i), the amount of the water-soluble polymer (CMC) per 100 parts by weight of the graphite particles was varied as in Table 2, and lithium ion secondary batteries were produced. The negative electrodes and the batteries were evaluated in the same manner as in Example 1. Table 2 shows the results. It should be noted that the battery having a specific surface area of the negative electrode mixture layer of more than 3 m²/g is a comparative example.

TABLE 2

| | | | | | Rate of |
|---|---|---|---|---|---|
| Amount of | | Specific | | | increase |
| water- | Specific | surface area | | | in |
| soluble | surface area | of negative | | | thickness |
| polymer | of dry | electrode | | | of coin |
| (part by | mixture | mixture layer | Tack test | Cycle | battery |
| weight) | (m²/g) | (m²/g) | (kgf/cm²) | test (%) | (%) |
| 0.4 | 4.5 | 3.3 | 14.5 | 93 | 18 |
| 0.5 | 4.3 | 2.9 | 15.6 | 93 | 13 |
| 0.8 | 3.2 | 2.8 | 16.9 | 93 | 11 |
| 1.0 | 3.0 | 2.75 | 18.2 | 93 | 10 |
| 2.0 | 2.95 | 2.4 | 18.6 | 92 | 11 |
| 2.5 | 2.9 | 2.2 | 18.6 | 91 | 11 |
| 3.0 | 2.9 | 2.5 | 18.9 | 89 | 15 |

As shown in Table 2, the batteries in which the amount of the water-soluble polymer contained in the negative electrode mixture layer was 0.5 to 2.5 parts by weight per 100 parts by weight of the graphite particles exhibited very small rates of increase in thickness. This is probably because the water-soluble polymer coated the graphite particle surface at a high coating rate, thereby suppressing decomposition of the electrolyte components due to reaction between the graphite particles and the non-aqueous electrolyte.

### Example 5

Negative electrodes were produced in the same manner as in Example 1, except that in the step (ii), the amount of the binder per 100 parts by weight of the graphite particles was varied as in Table 3, and lithium ion secondary batteries were produced. The negative electrodes and the batteries were evaluated in the same manner as in Example 1. Table 3 shows the results. It should be noted that the battery having a tack test value of less than 14 kgf/cm² is a comparative example.

TABLE 3

| | | | | | Rate of |
|---|---|---|---|---|---|
| | | Specific | | | increase |
| | Specific | surface area | | | in |
| Amount of | surface area | of negative | | | thickness |
| binder | of dry | electrode | | Cycle | of coin |
| (part by | mixture | mixture layer | Tack test | test | battery |
| weight) | (m²/g) | (m²/g) | (kgf/cm²) | (%) | (%) |
| 0.3 | 3.4 | 2.95 | 12 | 89 | 21 |
| 0.4 | 3.4 | 2.85 | 14.5 | 90 | 14 |
| 0.6 | 3.4 | 2.7 | 15.2 | 93 | 12 |
| 0.8 | 3.4 | 2.65 | 17.2 | 93 | 11 |
| 1.2 | 3.4 | 2.6 | 17.9 | 92 | 11 |
| 1.5 | 3.4 | 2.4 | 16.5 | 92 | 13 |
| 2.0 | 3.4 | 2.3 | 16.8 | 89 | 14 |

As shown in Table 3, the batteries in which the amount of the binder contained in the negative electrode mixture layer was 0.4 to 1.5 parts by weight per 100 parts by weight of the graphite particles exhibited good cycle characteristics and very small rates of increase in thickness. In the batteries of this example, since the graphite particle surface was coated with the water-soluble polymer, the sliding properties of the graphite particles are good. Therefore, the binder adhering to the graphite particle surface is subjected to a sufficient shearing force and acts on the graphite particle surface effectively. Probably for this reason, even when the amount of the binder was small, sufficient adhesion was exhibited.

### INDUSTRIAL APPLICABILITY

The invention is applicable to various negative electrodes for non-aqueous electrolyte secondary batteries having a negative electrode mixture layer which includes graphite particles, a binder for bonding the graphite particles, and a water-soluble polymer. According to the invention, since the reaction between the graphite particles and the non-aqueous electrolyte can be suppressed effectively, a non-aqueous electrolyte secondary battery with good coulombic efficiency can be obtained.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

10 Graphite Particle
15 Water-Soluble Polymer
20 Battery Can; 20a Bottom; 20b Side Wall
21 Electrode Assembly
22 Positive Electrode Lead
23 Negative Electrode Lead
24 Insulator
25 Seal Plate
26 Insulating Gasket
27 Negative Electrode Terminal
29 Seal Stopper

1. A negative electrode for a non-aqueous electrolyte secondary battery, comprising a negative electrode core member and a negative electrode mixture layer adhering to the negative electrode core member,
the negative electrode mixture layer including graphite particles, a water-soluble polymer coating the surfaces of the graphite particles, and a binder bonding the graphite particles coated with the water-soluble polymer,
the negative electrode mixture layer having a specific surface area of 2.2 to 3 m²/g, and
the bonding strength between the graphite particles coated with the water-soluble polymer being 14 kgf/cm² or more.

2. The negative electrode for a non-aqueous electrolyte secondary battery in accordance with claim 1, wherein the negative electrode mixture layer has a specific surface area of 2.6 to 3 m²/g.

3. The negative electrode for a non-aqueous electrolyte secondary battery in accordance with claim 1, wherein the graphite particles have a specific surface area of 4 to 6 m²/g.

4. The negative electrode for a non-aqueous electrolyte secondary battery in accordance with claim 1,
wherein the amount of the binder is 0.4 to 1.5 parts by weight per 100 parts by weight of the graphite particles, and
the amount of the water-soluble polymer is 0.5 to 2.5 parts by weight per 100 parts by weight of the graphite particles.

5. The negative electrode for a non-aqueous electrolyte secondary battery in accordance with claim 1, wherein the water-soluble polymer is a cellulose derivative.

6. The negative electrode for a non-aqueous electrolyte secondary battery in accordance with claim 1, wherein the binder is in the form of particles with a mean particle size of 0.1 to 0.3 μm and has rubber elasticity.

7. A non-aqueous electrolyte secondary battery comprising the negative electrode of claim 1, a positive electrode, a separator interposed between the negative electrode and the positive electrode, and a non-aqueous electrolyte.

8. A method for producing a negative electrode for a non-aqueous electrolyte secondary battery, comprising the steps of:
(i) mixing graphite particles with a specific surface area X of 4 to 6 m²/g, water, and a water-soluble polymer dissolved in the water, and drying the resulting mixture to obtain a dry mixture with a specific surface area Y of 2.9 to 4.3 m²/g where Y/X is from 0.6 to 0.8,
(ii) mixing the dry mixture, a binder, and a dispersion medium to form a negative electrode mixture slurry,
(iii) applying the negative electrode mixture slurry to a negative electrode core member and drying it to form a coating film, and
(iv) rolling the coating film at a line pressure of 40 to 60 kgf/cm to form a negative electrode mixture layer.

9. The method for producing a negative electrode for a non-aqueous electrolyte secondary battery in accordance with claim 8,
wherein the amount of the binder is 0.4 to 1.5 parts by weight per 100 parts by weight of the graphite particles, and
the amount of the water-soluble polymer is 0.5 to 2.5 parts by weight per 100 parts by weight of the graphite particles.

10. The method for producing a negative electrode for a non-aqueous electrolyte secondary battery in accordance with claim 8, wherein the water-soluble polymer is a cellulose derivative.

11. The method for producing a negative electrode for a non-aqueous electrolyte secondary battery in accordance with claim 8, wherein the binder is in the form of particles with a mean particle size of 0.1 to 0.3 μm and has rubber elasticity.
